(19) United States
(12) Patent Application Publication
(10) Pub. No.: US 2014/0009026 A1
(43) Pub. Date: Jan. 9, 2014

(54) SYNCHRONOUS MACHINE WITH OPTIMIZED EXCITATION DEVICE FIXED TO THE STATOR

(71) Applicants: Markus Klöpzig, Ebermannstadt (DE); Marco Schramm, Nurnberg (DE)

(72) Inventors: Markus Klöpzig, Ebermannstadt (DE); Marco Schramm, Nurnberg (DE)

(73) Assignee: Siemens Aktiengesellschaft, Munchen (DE)

(21) Appl. No.: 14/006,625

(22) PCT Filed: Mar. 2, 2012
(86) PCT No.: PCT/EP12/53656

§ 371 Date: Sep. 20, 2013

(30) Foreign Application Priority Data
Mar. 22, 2011 (EP) 11159192.1

(51) Int. Cl. H02K 1/24

(52) U.S. Cl. CPC H02K 1/243
USPC 310/156.69

(57) ABSTRACT

A synchronous machine has a rotor rotatable about an axis of rotation and a stator surrounding the rotor radially on the outside. When viewed in axial direction, the rotor has a number of rotor rings running tangentially around the axis of rotation. When viewed in tangential direction about the axis of rotation, the rotor rings each have a plurality of claws of soft-magnetic material. The claws are in the form of an L, defined by first and second limbs. An excitation device is fixed to the stator and has, for each rotor ring, a magnetic field generator which interacts with the respective rotor ring and is arranged radially inside the respective rotor ring. The magnetic field generator generates a magnetic field directed in the axial direction and is coupled magnetically to the second limb of the claws of the respective rotor ring in the region of the radially inner termination.

The present invention relates to a synchronous machine,
wherein the synchronous machine has a rotor able to be rotated around an axis of rotation and a stator surrounding the rotor radially on the outside,
wherein the rotor, viewed in the axial direction, has a number of rotor rings running tangentially around the axis of rotation,
wherein the rotor rings, viewed in the axial direction, each have an axial front and an axial rear termination,
wherein the rotor rings, viewed in the radial direction, each have a radial inner and a radial outer termination,
wherein the synchronous machine has an excitation device fixed to the stator which, for the rotor rings, has a magnetic field generator interacting with the respective rotor ring,
wherein the rotor rings, viewed in the tangential direction around the axis of rotation, each have a plurality of claws consisting of a soft-magnetic material,
wherein the claws are embodied in an L shape, so that they each have a first and a second limb,
wherein the first limbs form the radial outer termination of the respective rotor ring adjoining the stator,
wherein the second limbs run radially inwards alternately in the region of the axial front and the axial rear termination of the respective rotor ring.

Electrical machines are known in many embodiments, for example as direct current machines, as single-phase alternating current machines or as polyphase machines. With polyphase machines for their part a distinction is made between asynchronous machines and synchronous machines. The present invention relates to synchronous machines.

With synchronous machines the rotor must be excited. It is possible to effect the excitation by means of permanent magnets. With permanently-excited synchronous machines magnetic material based on rare earths is primarily used in order to achieve a torque and power density that is as high as possible. Furthermore these synchronous machines stand out especially in the part load range, for low speeds and high torque requirements through a relatively high efficiency, since almost no rotor-side losses arise as a result of the permanent magnet excitation. As an alternative synchronous machines can be electrically excited. With electrically-excited synchronous machines comparatively high rotor winding losses occur at high torque requirements, so that the efficiency of such synchronous machines in this range is lower than with permanent-magnetic excitation. Electrically-excited synchronous machines are however more efficient to operate in the field attenuation range at high speeds. In particular electrically-excited synchronous machines do not need any parasitic field attenuation current above the voltage limit, but merely a reduction of the excitation. This means that both the remagnetization losses and also the stator-side losses are reduced, since only torque-forming current (in the transverse axis) is needed.

Combining a permanent-magnet and an electrical excitation with one another is also already known. In this way the efficiency benefits of both excitation types can be enjoyed. In particular a basic excitation should be carried out with permanent magnets in this case. For short-term, high torque requirements the magnetic flux is increased in this case as a result of an additional electrical excitation.

With electrical excitation the electrical energy needed is fed into the rotor as a rule via slip ring systems or via transformer-based transmission systems. Slip ring systems are susceptible to wear, transformer-based transmission systems demand an increased material and cost outlay.

Generating a constant magnetic field by means of an excitation device fixed to the stator and transmitting the constant magnetic field to the rotor is known as an alternative. This procedure is characterized by a series of benefits. On the one hand no rotor windings are needed, which is why no copper losses and heating of the rotor caused thereby occur either. Since a constant magnetic field is involved, there are no remagnetization losses either. Any electromagnets of the excitation device fixed to the stator do not rotate and can therefore especially be cooled in a simple manner.

A synchronous machine of the type described at the start is known for example from U.S. Pat. No. 3,132,272 A.

A synchronous machine is known from GB 1 148 304 A,
wherein the synchronous machine has a rotor able to be rotated around an axis of rotation and a stator surrounding the rotor radially on the outside,
wherein the rotor, viewed in the axial direction, has a number of rotor rings running tangentially around the axis of rotation,
wherein the rotor rings, viewed in the axial direction, each have an axial front and an axial rear termination,
wherein the rotor rings, viewed in the radial direction, each have a radial inner and a radial outer termination,
wherein the synchronous machine has an excitation device fixed to the stator which, for the rotor rings, has a magnetic field generator interacting with the respective rotor ring,
wherein the rotor rings, viewed in the tangential direction around the axis of rotation, each have a plurality of claws consisting of a soft-magnetic material,
wherein the respective magnetic field generator is disposed radially within the respective rotor ring, generates a magnetic field directed in the axial direction and is coupled magnetically to the second limbs of the claws of the respective rotor ring in the region of the radial inner termination.

The object of the present invention consists of designing a synchronous machine, having an excitation device fixed to the stator, in an optimized manner.

The object is achieved by means of a synchronous machine having the features of claim 1. Advantageous embodiments of the inventive synchronous machine are the subject matter of the dependent claims 2 to 10.

Inventively there is provision for embodying a synchronous machine of the type described at the start so
that the respective magnetic field generator is disposed radially within the respective rotor ring, generates a magnetic field directed in the axial direction and is coupled magnetically to the second limbs of the claws of the respective rotor ring in the region of the radial inner termination and
that a radial distance between the outer side of the first limbs varies, viewed in the tangential direction around the axis of rotation.

To optimize the magnetic flux the magnetic field generator is preferably terminated on both sides axially with a flux flow element, by means of which the magnetic flux is directed radially outwards into the two limbs of the claws of the respective rotor ring.

Preferably the two limbs of the claws of the respective rotor ring become two flux consumer rings which surround the flux guidance elements radially on the outside. This enables it to be especially achieved that the flux transmission is evened-out.

In order to guarantee the stability of the rotor rings without negatively affecting the magnetic properties of the rotor rings, the rotor rings preferably consist of a filler material in the region between the claws, which is diamagnetic or paramagnetic and is electrically-insulating or only anisotropically conducting.

The magnetic field generator can alternatively be embodied as a permanent magnet, as an electromagnet or as a combination of a permanent magnet and an electromagnet.

In a preferred embodiment of the present invention the radial distance varies such that the radial distance between the radial outer side of the first limbs to the adjacent first limbs viewed in the tangential direction is minimal.

There can be any number of rotor rings. In many cases it is sufficient for only one rotor ring to be present. In many cases the number of rotor rings however is greater than one. For example 2, 3, 4 etc. rotor rings can be present.

If a number of rotor rings are present, in relation to rotor rings adjoining one another in the axial direction, the second limbs of the claws facing towards the respective other rotor ring are magnetized in the same direction.

The rotor rings have a periodicity, viewed in the tangential direction around the axis of rotation. In a possible embodiment of the present invention rotor rings adjoining one another in the axial direction are rotated by an angle around the axis of rotation in relation to each other, wherein the angle is smaller than a sixth of the periodicity. However this embodiment of the synchronous machine reduces its power yield (i.e. the power able to be achieved for a given size). On the other hand better synchronous operation is produced, since oscillating torque and cogging are reduced.

In the case of a number of rotor rings the magnetic field generators interacting with the rotor rings can be embodied in the same way, i.e. for example all as permanent magnets or all as electromagnets. The magnetic field generators can however be embodied independently of one another. It is thus possible for one of the magnetic field generators to be embodied as a permanent magnet and another of the magnetic field generators as an electromagnet or as a combination of a permanent magnet and an electromagnet or for the one magnetic field generator to be embodied as an electromagnet and the other magnetic field generator as a combination of a permanent magnet and an electromagnet.

Further advantages and details emerge from the description given below of an exemplary embodiment in combination with the drawings. The figures show the following basic diagrams:

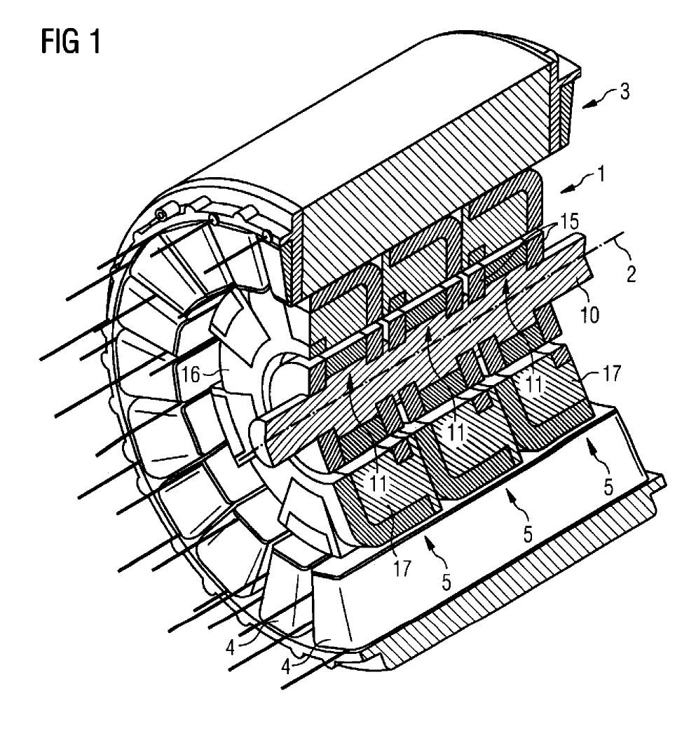

FIG. 1 shows a schematic of a synchronous machine in a perspective, part-sectional diagram,

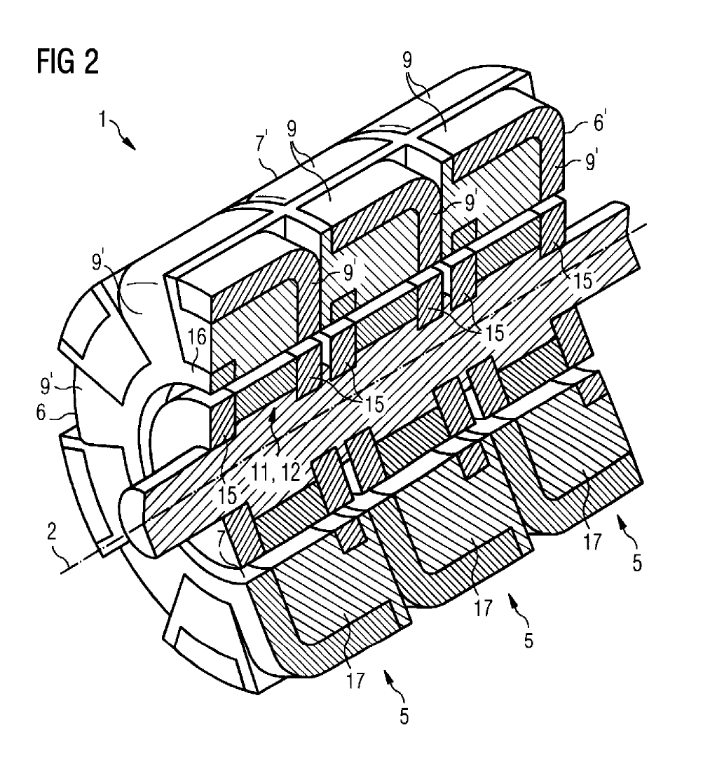

FIG. 2 shows a schematic of a rotor and an excitation device fixed to a stator of the synchronous machine from FIG. 1 in a perspective, part-sectional diagram,

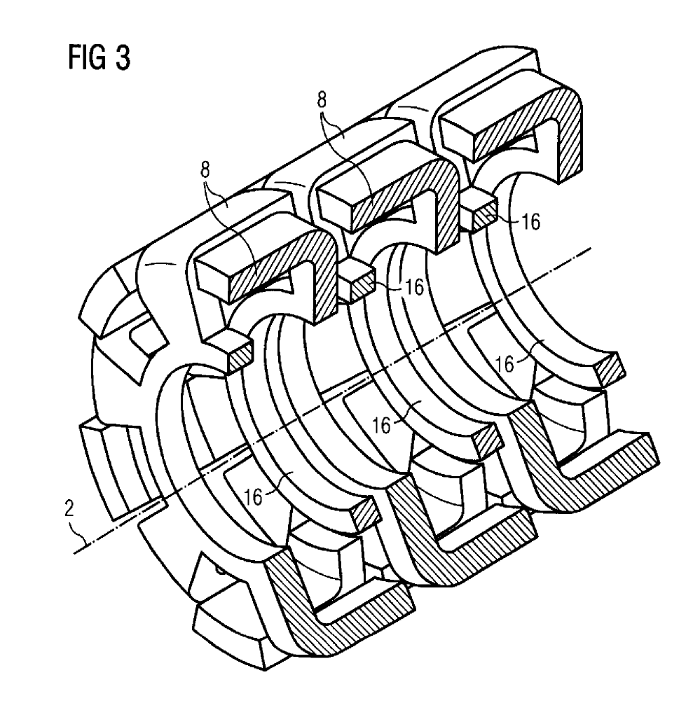

FIG. 3 shows a schematic of claws of the rotor from FIG. 2 in a perspective, part-sectional diagram,

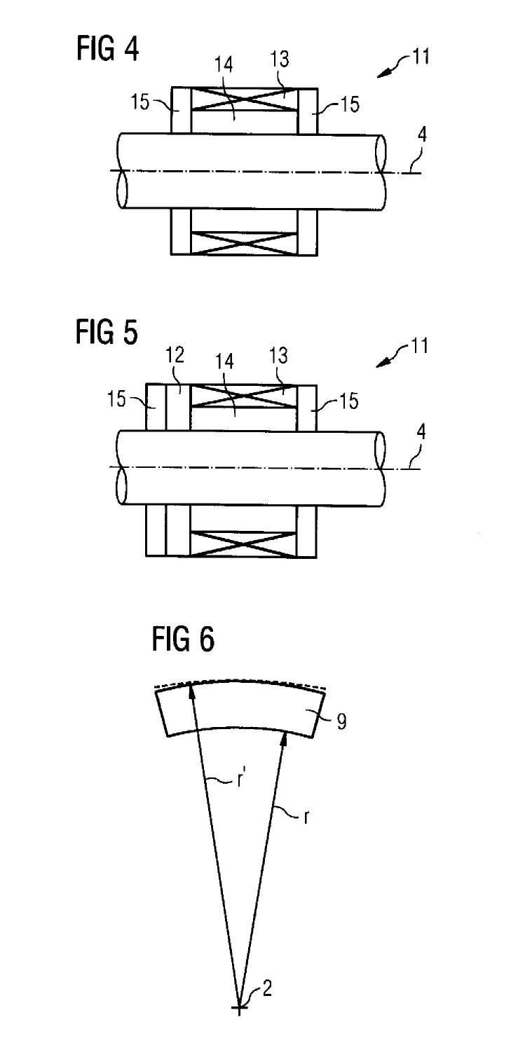

FIGS. 4 and 5 show schematics of possible embodiments of a magnetic field generator,

FIG. 6 shows a schematic of a cross section through a first limb and

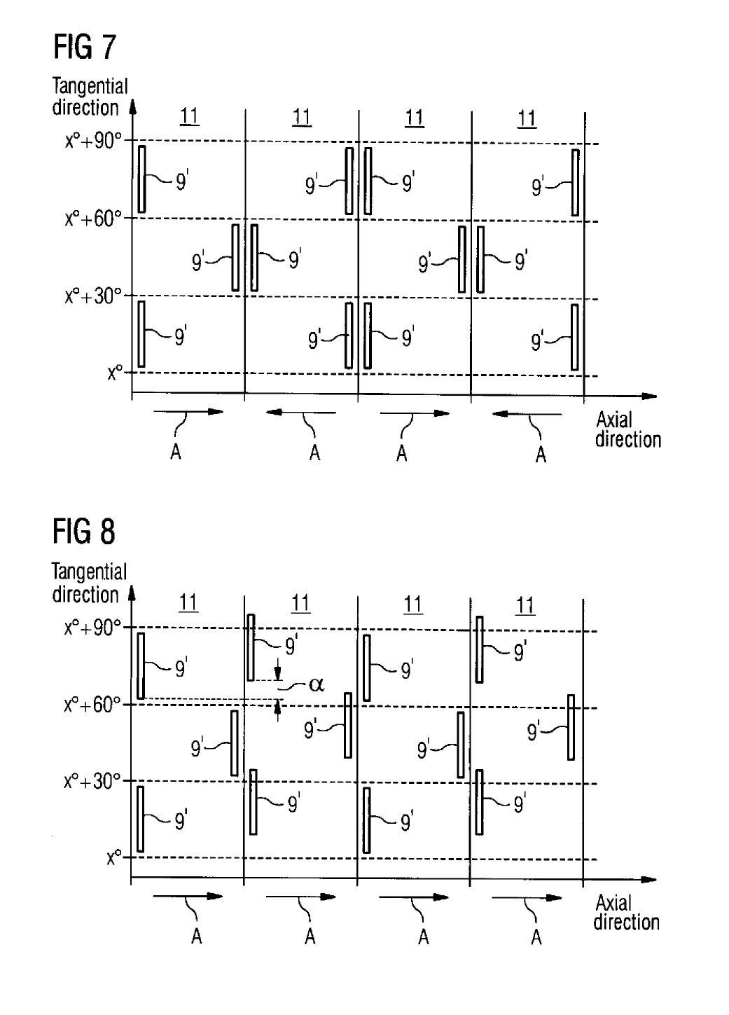

FIGS. 7 to 9 show schematics of possible sequences of second limbs in a rolled-out diagram.

According to FIGS. 1 to 3 a synchronous machine has a rotor 1. The rotor 1 is able to be rotated around an axis of rotation 2.

The synchronous machine also has a stator 3, which surrounds the rotor 1 radially on the outside. Disposed in the stator 3 are windings 4 of a polyphase system.

The axis of rotation 2 defines a cylindrical coordinate system of the synchronous machine. The terms “axial”, “radial” and “tangential” are always related to the axis of rotation 2. The term “axial” means a direction parallel to the axis of rotation 2. The term “radial” means a direction orthogonal to the axis of rotation 2 towards the axis of rotation 2 or away from it respectively. The term “tangential” means a direction which runs both orthogonal to the axial direction and also to the radial direction. The term “tangential” thus means a direction at a constant radial distance around the axis of rotation 2.

The rotor 1, viewed in the axial direction, has a number of rotor rings 5. The rotor rings 5 run tangentially around the axis of rotation 2. Three such rotor rings 5 are shown in FIGS. 1 to 3. However any number of rotor rings 5 is able to be chosen. As a minimum a single rotor ring is present. As an alternative, two, three, four etc. rotor rings 5 can be present.

The rotor rings 5, viewed in the axial direction, each have an axial front and an axial rear termination 6, 6′, They thus extend, viewed in the axle direction, from the respective axial front termination 6 to the respective axial rear termination 6′. In the same way the rotor rings 5, viewed in the radial direction, each have a radial inner and a radial outer termination 7, 7′. They thus extend, viewed in the radial direction, from the respective radial inner termination 7 to the respective radial outer termination 7′.

The rotor rings 5, viewed in the radial direction, do not extend to the axis of rotation 2. The radial inner terminations 7 of the rotor rings 5 are therefore spaced away from the axis of rotation 2.

As can be especially clearly seen from FIG. 3, the rotor rings 5 in the tangential direction, viewed around the axis of rotation 2, each have a plurality of claws 8. The claws 8 consist of a soft-magnetic material. Soft-magnetic materials, as is generally known to persons skilled in the art, are ferromagnetic materials which can be easily magnetized and guide and greatly strengthen an existing magnetic field. By contrast with permanent-magnetic materials however, they only have a very small hysteresis, are thus only themselves magnetic in the sense of permanently magnetic to a very small extent. Examples of these types of materials are soft iron and electrical steel. An alternate material is SMC (=sintered magnetic compound).

The claws 8 are—see especially FIG. 3—embodied in an L shape. They thus each have a first limb 9 and a second limb 9′. The first limbs 9 form the radial outer termination 7′ of the respective rotor ring 5 which adjoins the stator 3. The second limbs 9′ run alternately in the region of the axial front termination 6 and radially inwards in the region of the axial rear termination 6′ of the respective rotor ring 5.

The synchronous machine additionally has an excitation device 10 fixed to the stator. The excitation device 10 fixed to the stator has a magnetic field generator 11 for the rotor rings 5 in each case, which interacts with the respective rotor ring 5. The excitation device 10 fixed to the stator and with it the magnetic field generator 11 are disposed in the region of the axis of rotation 2. In particular the respective magnetic field generator 11 for the rotor rings 5 is disposed radially within the respective rotor ring 5.

The respective magnetic field generator 11 generates a magnetic field directed in an axial direction. For this purpose the magnetic field generator 11 can be embodied in accordance with the diagrams of FIGS. 1 to 3 as a permanent magnet 12. As an alternative—see FIG. 4—the magnetic field generator 11 can be embodied as an electromagnet 13 along with yoke 14. As a further alternative—see FIG. 5—the magnetic field generator 11 can be embodied as a combination of a permanent magnet 12 and an electromagnet 13 along with yoke 14. It is up to the person skilled in the art as to which of these embodiments is realized. Regardless of which embodiment is realized, the magnetic field generator 11 is however coupled in the region of the radial inner termination 7 of the respective rotor ring 5—especially in the transition area from the respective radial inner termination 7 to the axial terminations 6, 6′ of the respective rotor ring 5—magnetically to the second limb 9′ or the claws 8 of the respective rotor ring 5. The magnetic field generated by the magnetic field generator 11 is thus, starting from the magnetic field generator 11, directed into the second limbs 9′ and from there further into the first limbs 9.

For optimizing the introduction of the magnetic field into the second limbs 9′, the magnetic field generator 11 is also closed off axially on both sides by a flux guidance element 15 in each case. The flux guidance elements 15 are preferably embodied in the shape of a ring and convey the magnetic flux of the respective magnetic field generator 11 radially outwards into the second limbs 9′ of the claws 8 of the respective rotor ring 5.

It is possible for the second limbs 9′ running in the region of the axial front termination 6 not to be connected to each other at their radial inner ends. The same applies to the second limbs 9′ running in the region of the axial rear termination 6′. Preferably however the two limbs 9′ of the claws 8 of the respective rotor ring 5 become two flux consumer rings 16, which surround the flux guidance elements 15 radially on the outside. The flux consumer rings 16 are thus, especially viewed in the axial direction, disposed in the same axial area as the flux guidance elements 15. The rotor rings 5, in the region between the claws 8, consist of a filler material 17. The filler material 17 is preferably electrically and magnetically neutral. The magnetic neutrality is brought about especially by the filler material 17 being diamagnetic or paramagnetic. The electrical neutrality is brought about especially by the filler material 17 being electrically insulating. As an alternative the electrical neutrality can be brought about by the filler material 17 being electrically-conductive but by the conductivity being anisotropic. In particular in this case the electrical conductivity should only be provided in one direction and not provided in two directions orthogonal thereto. Examples of suitable filler materials 17 are glass fiber materials, carbon fiber materials and plastics (especially polyimides).

In accordance with FIG. 6 the first limbs 9 extend over a tangential area. The radial inner sides of the first limbs 9 are at a radial distance r from the axis of rotation 2. The radial outer sides of the first limbs 9 are at a radial distance r′ from the axis of rotation 2. The radial distance r of the radial inner sides is constant as a rule. The radial distance r′ of the radial outer sides can likewise be constant. This is indicated in FIG. 6 by a dashed line. As an alternative however, the radial distance r′ of the radial outer sides can vary, see the corresponding solid line in FIG. 6. In particular the radial distance r′ of the radial outer sides can be minimal towards the adjacent first limbs 9, viewed in the tangential direction.

The previous explanations of the present invention are independent of the number of rotor rings 5. The embodiments described below require that the number of rotor rings 5 is greater than one.

The individual rotor rings 5 exhibit a periodicity in the tangential direction around the axis of rotation 2 (often also referred to as pole spacing). As can be seen especially clearly from FIGS. 2 and 3, the rotor rings 5 have twelve claws 8 for example, so that per rotor ring 5 six second limbs 9′ run in the region of the axial front termination 6 and six second limbs 9′ run respectively in the region of the axial rear termination 6′ of the respective rotor ring 5 radially inwards. The periodicity thus amounts in the embodiment of FIGS. 1 to 3 to 360°/6=60°. With eight claws 8 the periodicity would accordingly be 90°, for twenty four claws 8 it would be 30°. The numbers given are of course only by way of example.

The example shown with twelve claws 8, i.e. the periodicity of 60°, is discussed in greater detail below. However, the information provided can be transferred to other periodicities in a similar manner.

It is possible for the rotor rings 5 to all be aligned similarly in accordance with the diagrams shown in FIGS. 1 to 3. As an alternative it is possible for rotor rings 5 following each other in the axial direction—at least approximately—to be rotated in relation to one another by the half of the periodicity, see FIG. 7. This embodiment has the advantage that the flux direction of the magnetic flux in the second limbs 9′ of adjacent rotor rings 5 facing towards each other is rectified. In this case the axial magnetic field generated by the corresponding magnetic field generators 11, as indicated in FIG. 7 by the corresponding arrows A, must be aligned in opposite directions. However this is not easily able to be realized. Because of the situation that through this embodiment in relation to the axial rotor rings 5 adjoining each other in the axial direction, the second limbs 9′ of the claws 8 facing towards the respective other rotor ring 5 are magnetized in same direction, the magnetic losses can be minimized.

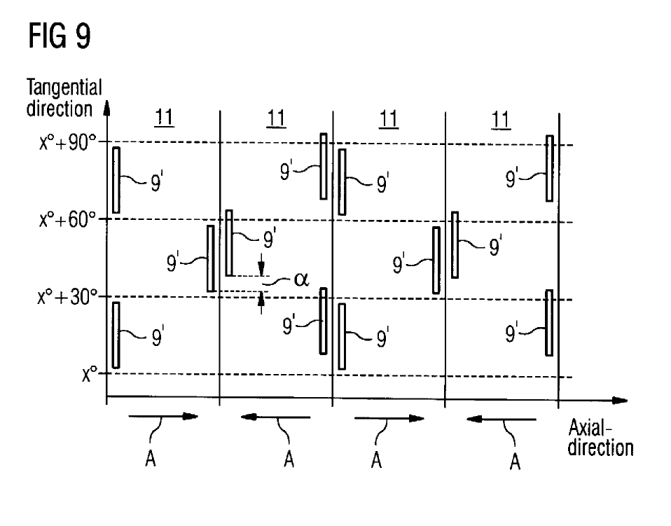

As an alternative or in addition it is possible—see FIGS. 8 and 9—for rotor rings 5 adjoining each other in the axial direction to be rotated by an angle α, which is significantly smaller than the periodicity, around the axis of rotation 2. In particular the angle a should be a maximum of ⅙ of the periodicity.

As already mentioned, the magnetic field generators 11 can alternately also be embodied as permanent magnets 12, as electromagnets 13 (with yoke 14) or as a combination of a permanent magnet 12 and an electromagnet 13 (with yoke 14). Furthermore the embodiment of the magnetic field generators 11 is independent of one another. It is thus possible to embody one of the magnetic field generators 11 as a permanent magnet 12, another as an electromagnet 13 along with yoke 14. It is likewise possible to embody one of the magnetic field generators 11 as a permanent magnet 12, another as a combination of a permanent magnet 12 and an electromagnet 13 along with yoke 14. It is likewise possible to embody one of the magnetic field generators 11 as an electromagnet 13 along with yoke 14, another of the magnetic field generators 11 as a combination of a permanent magnet 12 and an electromagnet 13 along with yoke 14. If at least three magnetic field generators 11 are present, it is even possible for each of the said embodiments to be realized at least once.

The present invention has many advantages. In particular the spatial separation of the feed of the exciter field from the torque-generating air gap between rotor 1 and stator 3 produces a superior run behavior of the synchronous machine with a simplified construction and high power density. As a result of the excitation device 10 fixed to the stator no further permanent magnets or electromagnets are necessary in the rotor rings 5. In the rotor 1, i.e. the most difficult-to-cool part of the synchronous machine, almost no heating up thus takes place as a result of ohmic winding losses or of eddy current losses in the permanent magnets. Losses occurring in the excitation device 10 fixed to the stator can on the other hand be dissipated relatively simply by cooling. Furthermore the magnetic field built up by the windings 4 on the stator side penetrates the magnetic field generators 11 of the excitation device 10 fixed to the stator to only a small extent. In the event of a stator-side short circuit and the associated high currents, a demagnetization of permanent magnets 12 is thus relatively simple to exclude.

As a result of the situation of energy not having to be transmitted either via slip rings or via a transformer into the rotor 1, the rotor 1 operates without wear, reliably and efficiently. The axial extent of the claws 8 can be kept comparatively small. This embodiment enables stray effects to be reduced. The overall power requirement of the synchronous machine can, if necessary, be met by a series arrangement of a number of rotor rings 5 behind one another.

The above description serves exclusively to explain the present invention. The scope of protection of the present invention on the other hand is to be defined exclusively by the enclosed claims.

1.-10. (canceled)

11. A synchronous machine, comprising:
a stator,
a rotor radially surrounded by the stator and rotatable around an axis of rotation, said rotor having a number of rotor rings which run tangentially around the axis of rotation in an axial direction, each of said rotor rings having in the axial direction an axial front termination and an axial rear termination and in a radial direction a radial inner and a radial outer termination, each of said rotor rings, when viewed in a tangential direction around the axis of rotation, having a plurality of claws made of a soft-magnetic material, said claws having each an L-shaped configuration to define first and second limbs, with the first limbs of the claws forming the radial outer termination of the rotor rings adjoining the stator, and with the second limbs of the claws running radially inwards alternately in a region of the axial front and axial rear terminations of the respective rotor rings, said first limbs having a radial outer side at a radial distance from the axis of rotation, said radial distance varying, when viewed in the tangential direction; and
an excitation device fixed to the stator and having magnetic field generators interacting with the rotor rings of the rotor in one-to-one correspondence and disposed radially within the radially inner rotor rings, said magnetic field generators configured to generate a magnetic field directed in the axial direction and coupled magnetically to the second limbs of the claws of the rotor rings in the region of the radial inner terminations.

12. The synchronous machine of claim 11, wherein the magnetic field generators are each terminated axially on both sides with flux guidance elements to direct the magnetic flux radially outwards into the second limbs of the claws of the rotor rings.

13. The synchronous machine of claim 12, wherein the second limbs of the claws of the rotor rings merge into two flux consumer rings in radial surrounding relationship to the flux guidance elements.

14. The synchronous machine of claim 11, wherein the rotor rings include in a region between the claws a filler material which is diamagnetic or paramagnetic and is electrically isolating or only anisotropically conductive.

15. The synchronous machine of claim 11, wherein the magnetic field generators are configured as a member selected from the group consisting of permanent magnet, electromagnet, and a combination of a permanent magnet and an electromagnet.

16. The synchronous machine of claim 11, wherein the radial distance of the radial outer side of adjacent first limbs is at a minimum, when viewed in the tangential direction.

17. The synchronous machine of claim 11, wherein the number of rotor rings is greater than one.

18. The synchronous machine of claim 11, wherein in relation to adjoining rotor rings in the axial direction, the second limbs of the claws facing towards the other rotor ring are magnetized in a same direction.

19. The synchronous machine of claim 11, wherein the rotor rings, viewed in the tangential direction around the axis of rotation, have a periodicity, wherein adjoining rotor rings in the axial direction are rotated around the axis of rotation in relation to one another by an angle which is smaller than one sixth of the periodicity.

20. The synchronous machine of claim 11, wherein one of the magnetic field generators is configured as a permanent magnet, and another one of the magnetic field generators is configured as an electromagnet or a combination of a permanent magnet and an electromagnet, or that the one magnetic field generator is configured as an electromagnet and the other magnetic field generator is configured as a combination of a permanent magnet and an electromagnet.
